(19) United States
(12) Patent Application Publication
(10) Pub. No.: US 2026/0210547 A1
(43) Pub. Date: Jul. 23, 2026

(54) GAS TURBINE ENGINE INCLUDING FLOW TURNING COMBUSTOR

(71) Applicant: General Electric Company, Evendale, OH (US)

(72) Inventors: Miles Burnett, Cincinnati, OH (US); Sibtosh Pal, Mason, OH (US); Steven C. Vise, Loveland, OH (US); Keith W. Wilkinson, Portsmouth, NH (US); Pradeep Naik, Bengaluru (IN)

(21) Appl. No.: 19/033,730

(22) Filed: Jan. 22, 2025

(51) Int. Cl. F23R 3/16; F23R 3/28

(52) U.S. Cl. CPC F23R 3/16; F23R 3/28

(57) ABSTRACT

A gas turbine engine, comprising: a compressor section, a combustion section, and a turbine section, with the combustion section including: a flow turning combustor comprising: a combustor liner that at least partially defines a combustion chamber including: a combustor inlet having an inlet height, a combustor outlet having an outlet height and fluidly coupled with the turbine section; a primary section extending from the combustor inlet and including a primary length; and a transition section extending from the primary section to the combustor outlet and defining a turn; a hydrogen fuel supply; and a fuel nozzle assembly fluidly coupled with the hydrogen fuel supply and the combustor inlet.

### TECHNICAL FIELD

The present subject matter relates generally to a gas turbine engine having a flow turning combustor.

### BACKGROUND

Turbine engines are driven by a flow of combustion gases passing through the engine to rotate a multitude of turbine blades, which, in turn, rotate a compressor to provide compressed air to the combustor for combustion. A combustor can be provided within the turbine engine and is fluidly coupled with a turbine into which the combusted gases flow.

Historically, hydrocarbon fuels are used in the combustor of a turbine engine. Generally, air and fuel are fed to a combustion chamber, the air and fuel are mixed, and then the fuel is burned in the presence of the air to produce hot gas. The hot gas is then fed to a turbine where it cools and expands to produce power. By-products of the fuel combustion typically include environmentally unwanted byproducts, such as nitrogen oxide and nitrogen dioxide (collectively called NOₓ), carbon monoxide (CO), unburned hydrocarbons (UHC) (e.g., methane and volatile organic compounds that contribute to the formation of atmospheric ozone), and other oxides, including oxides of sulfur (e.g., SO₂ and SO₃).

To reduce the environmentally unwanted byproducts, other fuels, such as hydrogen, are being explored. Hydrogen or hydrogen mixed with another element has a higher flame temperature than traditional hydrocarbon fuels. That is, hydrogen or a hydrogen mixed fuel typically has a wider flammable range and a faster burning velocity than traditional hydrocarbon-based fuels.

### BRIEF DESCRIPTION OF THE DRAWINGS

In the drawings:

FIG. 1 is a schematic view of a gas turbine engine having a compression section, a combustion section, and a turbine section in accordance with various aspects described herein.

FIG. 2 is a schematic view of portions of a combustion section including a flow turning combustor in accordance with various aspects described herein.

FIG. 3A is a schematic view of portions of a flow turning combustor in accordance with various aspects described herein.

FIG. 3B is a schematic view of portions of a flow turning combustor in accordance with various aspects described herein.

FIG. 3C is a schematic view of portions of a flow turning combustor in accordance with various aspects described herein.

FIG. 3D is a schematic view of portions of a flow turning combustor in accordance with various aspects described herein.

FIG. 3E is a schematic view of portions of a flow turning combustor in accordance with various aspects described herein.

FIG. 4 is a flow diagram illustrating a method of forming a flow turning combustor in accordance with various aspects described herein.

### DETAILED DESCRIPTION

Aspects of the disclosure described herein are directed to a combustor. With some aspects, the disclosed combustors and fuel nozzle assemblies are utilized with gaseous fuel, such as hydrogen. Gaseous fuel, including hydrogen, spreads/disperses at a faster rate than liquid fuel, due to the lack of fuel atomization required prior to injection into the combustor. Hydrogen has a high diffusivity, higher flame speed, and lower minimum ignition energy, which can allow for both shorter fuel mixing lengths and shorter overall combustor length for complete combustion.

Large combustor volumes and longer residence times may be used with liquid fuel, such as Jet-A, to facilitate altitude relight. Utilizing hydrogen fuel allows for smaller combustor volumes, which can allow for more compact and lighter combustors. Flow turning combustors described herein can be utilized with hydrogen, can include smaller combustor volumes, and can provide shorter residence times, which can reduce NOₓ emissions.

Many other possible aspects and configurations in addition to those shown in the included figures are contemplated by the present disclosure.

For purposes of illustration, the present disclosure will be described with respect to a turbine engine. It will be understood, however, that aspects of the disclosure described herein are not so limited. A combustor as described herein can be implemented in various engines, including but not limited to turbojet, turboprop, turboshaft, and turbofan engines. Aspects of the disclosure discussed herein may have general applicability within non-aircraft engines having a combustor, such as other mobile applications and non-mobile industrial, commercial, and residential applications.

With the combustors and fuel nozzle assemblies described herein, gaseous hydrogen fuel can be used without the need of diluents. In some embodiments, no diluent is added to the combustion chamber and the fuel is substantially completely diatomic hydrogen without diluent. As used herein, the term “substantially completely,” is used to describe the amount of a particular element or molecule (e.g., diatomic hydrogen), refers to at least 99% by mass of the described portion of the element or molecule, such as at least 97.5%, such as at least 95%, such as at least 92.5%, such as at least 90%, such as at least 85%, or such as at least 75% by mass of the described portion of the element or molecule. In some examples, the fuel is entirely (e.g., 100%) hydrogen by mass.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The terms like “first”, “second”, etc. may be used interchangeably to distinguish one component from another and are not intended to signify location or importance of the individual components.

The terms “forward” and “aft” refer to relative positions within a gas turbine engine or vehicle and refer to the normal operational attitude of the gas turbine engine or vehicle. For example, with regard to a gas turbine engine, forward refers to a position closer to an engine inlet and aft refers to a position closer to an engine exhaust.

As used herein, the term “upstream” refers to a direction that is opposite the fluid flow direction, and the term “downstream” refers to a direction that is in the same direction as the fluid flow. The term “fore” or “forward” means in front of something and “aft” or “rearward” means behind something. For example, when used in terms of fluid flow, fore/forward can mean upstream and aft/rearward can mean downstream.

The term “fluid” may be a gas or a liquid. The term “fluidly coupled” means that a fluid is capable of making the connection between the areas specified.

The term “nozzle” has been used in various ways in the context of gas turbine engines. In the instant application, “nozzle” refers to a component having a portion for fluid coupling to a fuel supply and having at least one portion for fluidly coupling with a combustor portion, a combustor liner, a combustion chamber, or combinations thereof.

As used herein, the terms “axial” and “axially” refer to directions and orientations that extend substantially parallel to a centerline of the turbine engine and/or a bearing assembly. Moreover, the terms “radial” or “radially” refer to a direction away from a common center. For example, in the overall context of a turbine engine, radial refers to a direction along a ray extending between a center longitudinal axis of the engine and an outer engine circumference. In addition, as used herein, the terms “circumferential” and “circumferentially” refer to directions and orientations that extend arcuately about the centerline of the turbine engine and/or the bearing assembly.

All directional references (e.g., radial, axial, proximal, distal, upper, lower, upward, downward, left, right, lateral, front, back, top, bottom, above, below, vertical, horizontal, clockwise, counterclockwise, upstream, downstream, forward, aft, etc.) are only used for identification purposes to aid the reader's understanding of the present disclosure, and do not create limitations, particularly as to the position, orientation, or use of aspects of the disclosure described herein. Connection references (e.g., attached, coupled, connected, and joined) are to be construed broadly and can include intermediate structural elements between a collection of elements and relative movement between elements unless otherwise indicated. As such, connection references do not necessarily infer that two elements are directly connected and in fixed relation to one another. The exemplary drawings are for purposes of illustration only, and the dimensions, positions, order, and relative sizes reflected in the drawings attached hereto can vary.

The singular forms “a”, “an”, and “the” include plural references unless the context clearly dictates otherwise. Furthermore, as used herein, the term “set” or a “set” of elements can be any number of elements, including only one.

Uses of “and” and “or” are to be construed broadly. For example, and without limitation, uses of “and” do not necessarily require all elements or features listed, and uses of “or” are inclusive unless such a construction would be illogical.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, “generally”, and “substantially”, are not to be limited to the precise value specified. In at least some instances, the approximating language may correspond to the precision of an instrument for measuring the value, or the precision of the methods or machines for constructing or manufacturing the components and systems. In at least some instances, the approximating language may correspond to the precision of an instrument for measuring the value, or the precision of the methods or machines for constructing or manufacturing the components and systems. For example, the approximating language may refer to being within a 1, 2, 4, 5, 10, 15, or 20 percent margin in either individual values, range(s) of values and endpoints defining range(s) of values. Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

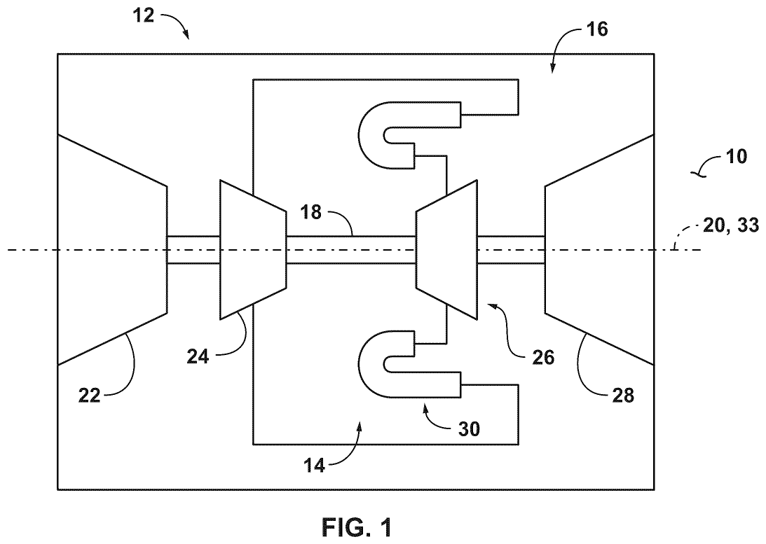

FIG. 1 is a schematic view of a gas turbine engine 10. As a non-limiting example, the gas turbine engine 10 can be used within an aircraft. The gas turbine engine 10 can include, at least, a compressor section 12, a combustion section 14, and a turbine section 16 in a serial flow arrangement. A drive shaft 18 rotationally couples the compressor section 12 and the turbine section 16, such that rotation of one affects the rotation of the other and defines a rotational axis 20 for the gas turbine engine 10.

The compressor section 12 can include a low-pressure (LP) compressor 22, and a high-pressure (HP) compressor 24 serially fluidly coupled to one another. The turbine section 16 can include an HP turbine 26, and an LP turbine 28 serially fluidly coupled to one another. The drive shaft 18 can operatively couple the LP compressor 22, the HP compressor 24, the HP turbine 26 and the LP turbine 28 together. Alternatively, the drive shaft 18 can include an LP drive shaft and an HP drive shaft. The LP drive shaft can couple the LP compressor 22 to the LP turbine 28, and the HP drive shaft can couple the HP compressor 24 to the HP turbine 26. An LP spool can be defined as the combination of the LP compressor 22, the LP turbine 28, and the LP drive shaft such that the rotation of the LP turbine 28 can apply a driving force to the LP drive shaft, which in turn can rotate the LP compressor 22. An HP spool can be defined as the combination of the HP compressor 24, the HP turbine 26, and the HP drive shaft such that the rotation of the HP turbine 26 can apply a driving force to the HP drive shaft which in turn can rotate the HP compressor 24.

The compressor section 12 can include a plurality of axially spaced stages. Each stage includes a set of circumferentially-spaced rotating blades and a set of circumferentially-spaced stationary vanes. The compressor blades for a stage of the compressor section 12 can be mounted to a disk, which is mounted to the drive shaft 18. Each set of blades for a given stage can have its own disk. The vanes of the compressor section 12 can be mounted to a shroud or casing, which can extend circumferentially about and enshroud one or more sections of the gas turbine engine 10. The representation of the compressor section 12 is merely schematic and there can be any number of blades, vanes, and compressor stages. Further, there can be any number of other components within the compressor section 12.

Similar to the compressor section 12, the turbine section 16 can include a plurality of axially spaced stages, with each stage having a set of circumferentially-spaced, rotating blades and a set of circumferentially-spaced, stationary vanes. The turbine blades for a stage of the turbine section 16 can be mounted to a disk which is mounted to the drive shaft 18. Each set of blades for a given stage can have its own disk. The vanes of the turbine section 16 can be mounted to the shroud or casing in a circumferential manner. There can be any number of blades, vanes, and turbine stages as the illustrated turbine section 16 is merely a schematic representation. There can be any number of other components within the turbine section 16.

The combustion section 14 can be provided, at least partially, serially between the compressor section 12 and the turbine section 16. In some configurations, portions of the turbine section 16 are axially aligned with and radially inward of portions of the combustion section 14. The combustion section 14 can be fluidly coupled to at least a portion of the compressor section 12 and the turbine section 16 such that the combustion section 14 at least partially fluidly couples the compressor section 12 to the turbine section 16. As a non-limiting example, the combustion section 14 can be fluidly coupled to the HP compressor 24 at an upstream end of the combustion section 14 and to the HP turbine 26 at a downstream end of the combustion section 14. The combustion section 14 can include a combustor 30. The combustor 30 can be a flow turning combustor, which, in some examples, can include a reverse flow combustor.

During operation of the gas turbine engine 10, ambient or atmospheric air is drawn into the compressor section 12 via a fan (not illustrated) upstream of the compressor section 12, where the air is compressed defining a pressurized air. The pressurized air can then flow into the combustion section 14 where the pressurized air is mixed with fuel and ignited, thereby generating combustion gases. Some work is extracted from these combustion gases by the HP turbine 26, which drives the HP compressor 24. The combustion gases are discharged into the LP turbine 28, which extracts additional work to drive the LP compressor 22, and the exhaust gas is ultimately discharged from the gas turbine engine 10 via an exhaust section (not illustrated) downstream of the turbine section 16. The driving of the LP turbine 28 drives the LP spool to rotate the fan (not illustrated) and the LP compressor 22. The pressurized airflow and the combustion gases can together define a working airflow that flows through the fan, compressor section 12, combustion section 14, and turbine section 16 of the gas turbine engine 10. A combustion section centerline 33 of the combustion section 14 can be colinear with the rotational axis 20.

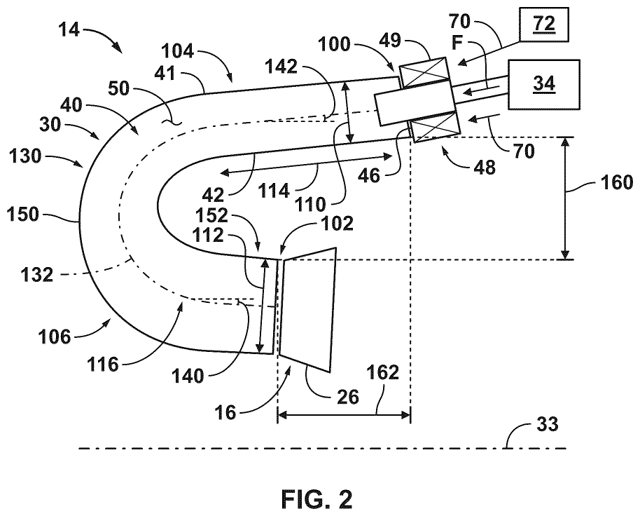

FIG. 2 depicts a cross-sectional view of portions of the combustion section 14. The combustion section 14 can include the combustor 30 with an annular arrangement about the combustion section centerline 33. A fuel nozzle assembly 48 can be fluidly coupled to the combustor 30.

The combustor 30 can be at least partially defined by a combustor liner 40. The combustor liner 40 can include an outer liner 41 and an inner liner 42. The combustor liner 40 can include the outer liner 41 spaced from the inner liner 42. In some examples, the combustor liner 40 can have an annular structure at least partially defining the combustor 30. The combustor liner 40 can include multiple segments or portions collectively forming the combustor liner 40. In some examples, the combustor liner 40 can include a single liner.

The combustor liner 40 can at least partially define a combustion chamber 50 arranged about combustion section centerline 33. The combustion chamber 50 can include a combustor inlet 100, a combustor outlet 102, a primary section 104, a transition section 106, or combinations thereof. The combustor inlet 100 can include a wall 46 (e.g., a dome wall) and can extend to the outer liner 41, the inner liner 42, or both.

The combustion section 14 can include or be fluidly coupled to a fuel supply 34 (e.g., a fuel manifold or conduit) that supplies fuel F. For example, the fuel nozzle assembly 48 can fluidly couple the fuel supply 34 with the combustor 30 and the combustion chamber 50, such as to provide a mixture of fuel F and air 70 to the combustion chamber 50. The fuel nozzle assembly 48 can be coupled to the wall 46 and the combustor inlet 100. Fuel F can include, for example, gaseous fuel, such as hydrogen fuel, which can include 100% H₂ (e.g., without diluents). With some examples, the fuel supply 34 is a hydrogen fuel supply, the fuel nozzle assembly 48 is a hydrogen fuel nozzle assembly, the combustor 30 is a flow turning hydrogen combustor, the combustor 30 is a reverse flow hydrogen combustor, or combinations thereof. The fuel nozzle assembly 48 can include a swirler 49 to swirl air 70 and emit swirled air into the combustion chamber 50, such as along with fuel F. The swirler 49 can be fluidly coupled with an air supply 72, which can, for example, include or be fluidly coupled to the compressor section 12 (FIG. 1). In some examples, the combustion section 14 includes a plurality of fuel nozzle assemblies 48, which can each include a respective swirler 49, arranged circumferentially about the combustion section centerline 33 to emit fuel For fuel F and air 70 into the combustion chamber 50. Additionally or alternatively, the combustor 30 can include one or more dilution holes at various locations to introduce air 70 into the combustion chamber 50.

The combustor 30 can include a flow turning configuration. The flow turning configuration can include the combustor 30 including a turn 130 that changes the direction of fluid flow, such as the flow of fuel F and air 70, in the combustion chamber 50 between the combustor inlet 100 and the combustor outlet 102. The turn 130 can be at least 60 degrees and less than or equal to 240 degrees. With turns 130 of greater than 90 degrees, the flow turning configuration can include a reverse flow configuration (e.g., the combustor 30 with the flow turning configuration can be a reverse flow combustor).

The combustor inlet 100 includes an inlet height 110 and is fluidly coupled with the air supply 72 (e.g., the compressor section 12 (FIG. 1)). The combustor outlet 102 includes an outlet height 112 and is fluidly coupled with the turbine section 16, such as with the HP turbine 26. In the illustrated example, portions of the turbine section 16, such as some or all of the HP turbine 26, are axially aligned with the combustor 30 (e.g., the primary section 104). For example, some or all of the HP turbine 26 can be disposed directly radially between the combustion section centerline 33 and the primary section 104. Such an overlapping configuration can reduce the size of the gas turbine engine 10 (FIG. 1). The primary section 104 extends from the combustor inlet 100 and includes a primary length 114. The transition section 106 extends from the primary section 104 to the combustor outlet 102 and defines the turn 130. For example, the primary section 104 can be a straight section, and the transition section 106 can extend from the primary section 104 (e.g., the straight section) and be curved to form the turn 130. While illustrated with a single turn 130, the transition section 106 can define a plurality of turns including the turn 130.

The combustor 30 defines a combustor centerline 132 extending from the combustor inlet 100 to the combustor outlet 102, and includes a combustor length 116 measured along the combustor centerline 132 from the combustor inlet 100 to the combustor outlet 102.

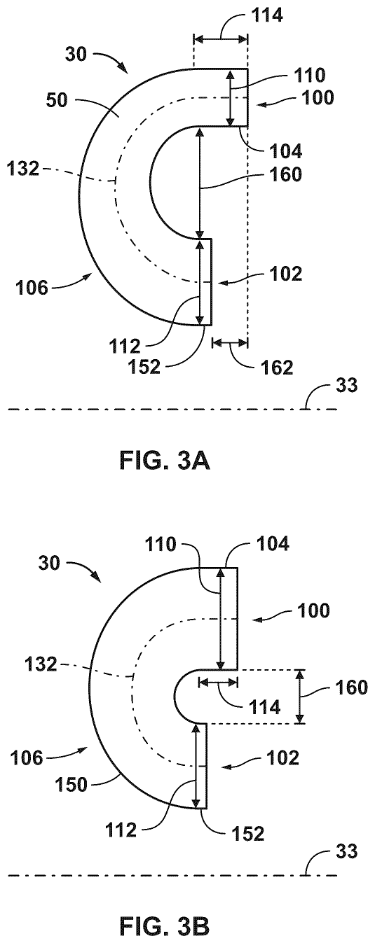

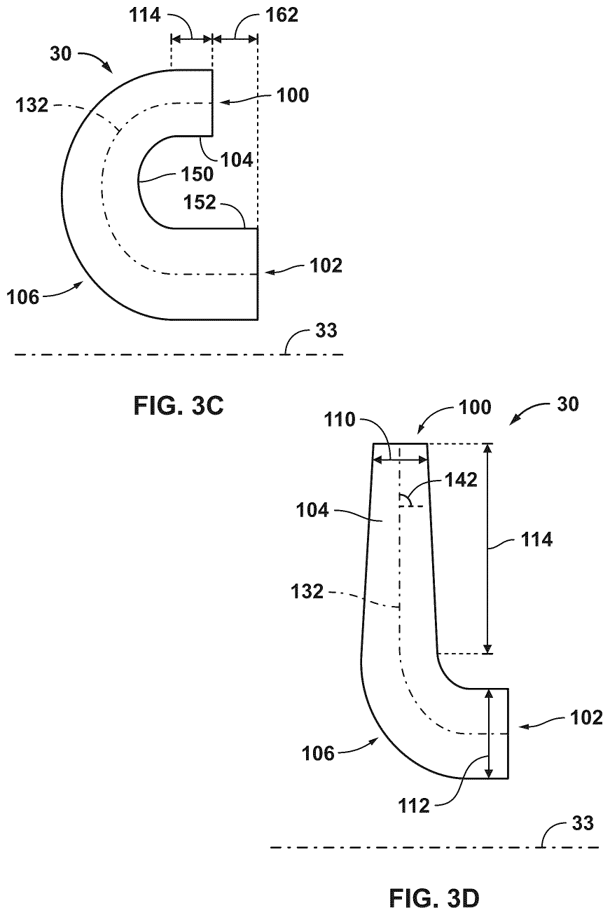

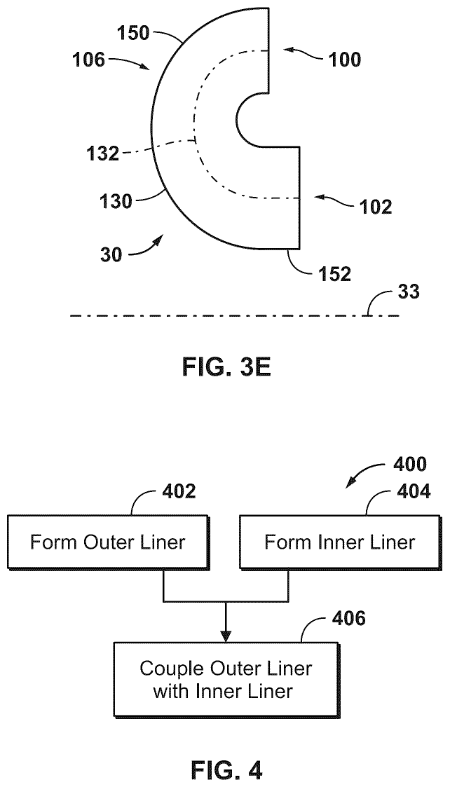

A ratio of a first product of the combustor length 116 and the outlet height 112 to a second product of the inlet height 110 and the primary length 114 is at least 2. In some examples, the ratio is at least 2.5. Such a configuration can provide a desired residence time for fuel F (e.g., hydrogen fuel) that allows for reducing or minimizing NOx emissions. In some examples (see, e.g., FIG. 3E), the combustor 30 does not include the primary section 104 and the primary length 114 would be zero, which results in the second product equaling zero and the ratio being infinite. In examples with the primary section 104 significantly shorter than the combustor length 116 or the outlet height 112, the ratio can approach infinity.

In some examples, the inlet height 110 can be at least 20% and less than 150% of the outlet height 112, which can provide a more consistent cross-sectional area of the combustion chamber 50. The outlet height 112 can, in some examples, be greater than the inlet height 110. In some examples, the combustor inlet 100 is aft of the combustor outlet 102.

The combustor centerline 132 at the combustor outlet 102 is angled at a first angle 140 relative to the combustion section centerline 33. The first angle 140 can be at least −30 degrees and less than 30 degrees, with negative angles being angled radially inward and positive angles being angled radially outward relative to the combustion section centerline 33. Additionally or alternatively, the combustor centerline 132 at the combustor inlet 100 is angled at a second angle 142 relative to the combustion section centerline 33. The second angle 142 can be at least −30 degrees and less than or equal to 90 degrees. In some examples, the second angle 142 is at least 80 degrees. The turn 130 can be defined as the change in flow direction between the combustor inlet 100 and the combustor outlet 102, and can be measured as 180 degrees plus the first angle 140 minus the second angle 142. For example, if both the first angle 140 and the second angle 142 are equal to 0 degrees, the turn 130 is 180 degrees. In another example, with the first angle 140 equal to −30 degrees and the second angle 142 equal to 90 degrees, the turn 130 is 60 degrees. In another example, with the first angle 140 equal to 30 degrees and the second angle 142 equal to −30 degrees, the turn 130 is 240 degrees. In the example illustrated in FIG. 2, the first angle 140 is about −5 degrees and the second angle 142 is about 5 degrees, so the turn 130 is about 170 degrees.

The flow turning configuration of the combustor 30 can include the combustor centerline 132 including a U-shaped configuration. For example, the fuel nozzle assembly 48 can be positioned to emit fuel F (e.g., hydrogen fuel) forward, at least to some degree, into the combustor 30 and the combustion chamber 50.

The transition section 106 can include a first portion 150 defining the turn 130 and a second portion 152 that is straight. The first portion 150 can extend from the primary section 104 or the combustor inlet 102 to the second portion 152. The second portion 152 extends from the first portion 150 to the combustor outlet 102.

The combustor inlet 100 and the combustor outlet 102 can be radially offset. For example, a radial offset 160 between the combustor inlet 100 and the combustor outlet 102 can be at least 30% and less than or equal to 250% of the outlet height 112. The radial offset 160 can be measured in the radial direction between the most radially outward portion of the combustor outlet 102 and the most radially inward portion of the combustor inlet 100. The combustor inlet 100 and the combustor outlet 102 can be axially offset. For example, an axial offset 162 between the combustor inlet 100 and the combustor outlet 102 can be greater 0% and less than or equal to 400% of the outlet height 112. The axial offset 162 can be measured in the axial direction between an aftmost portion of the combustor outlet 102 and an aftmost portion of the combustor inlet 100. In the example illustrated in FIG. 2, the axial offset 162 is provided with the combustor inlet 100 aft of the combustor outlet 102. However, the axial offset 162 can, alternatively, be provided with the combustor outlet 102 aft of the combustor inlet 100 (see FIG. 3C). The axial offset 162 is a positive value regardless of whether the combustor inlet 100 is aft or forward of the combustor outlet 102. In some other examples, the combustor inlet 100 and the combustor outlet 102 are axially aligned and the axial offset 162 is zero.

While illustrated with the fuel nozzle assembly 48 coupled with the combustor inlet 100, the combustor 30 can include one or more additional fuel inputs, air inputs, or both, which can be spaced along the combustor liner 40 in various configurations.

Referring to FIGS. 3A-3E, the combustor 30 can include a variety of configurations that may not be feasible with other designs, such as designs with dimensions dictated by altitude relight requirements. For example, the lower minimum ignition energy of hydrogen (e.g., one or more orders of magnitude lower than Jet-A) can allow for a greater range of configurations while still allowing for relight at altitude. The combustion section centerline 33 is illustrated in FIGS. 3A-3E for reference. In the illustrated configurations, the combustor inlet 100 is radially outward of the combustor outlet 102 relative to the combustion section centerline 33. The illustrated configurations can allow for shorter engines that weigh less, that have less nacelle scrub drag, or both. With some examples, the combustor 30 can include U-shaped configurations (FIGS. 3A-3C, 3E) or an L-shaped configuration (FIG. 3D), among other configurations.

Referring to FIGS. 3A and 3B, the combustor 30 can be U-shaped with the combustor inlet 100 aft of the combustor outlet 102, which can include the second portion 152 of the transition section 106 being shorter than the primary section 104 (e.g., shorter than the primary length 114), the primary section 104 extending farther aft than the second portion 152, or both.

Referring to FIG. 3A, a cross-sectional area of the combustor inlet 100 of the combustion chamber 50 can be less than a cross-sectional area of the combustor outlet 102, the inlet height 110 can be less than the outlet height 112, or both. The cross-sectional area of the combustor inlet 100 and the combustor outlet 102 can, for example, be measured in planes perpendicular to the combustor centerline 132. The radial offset 160 between the combustor inlet 100 and the combustor outlet 102 can be at least 30% and less than or equal to 250% of the outlet height 112. For example, the radial offset 160 can be at least 120% and less than or equal to 200% of the outlet height 112. The combustor inlet 100 can be aft of the combustor outlet 102 by the axial offset 162. The illustrated configuration can provide more radial space for the HP turbine 26 (FIG. 2), such as a stator structure thereof, provide more radial space for a clearance control system for the HP turbine 26 (FIG. 2), provide more radial space for an internal fuel manifold, or a combination thereof.

Referring to FIG. 3B, the cross-sectional area of the combustor inlet 100 can be greater than the cross-sectional area of the combustor outlet 102, the inlet height 110 can be greater than the outlet height 112, or both. The radial offset 160 between the combustor inlet 100 and the combustor outlet 102 can be at least 50% and less than or equal to 75% of the outlet height 112. The illustrated configuration can allow for smaller engine diameters, which allows for lighter engines, while maximizing dome and fuel injection radial height.

Referring to FIG. 3C, the combustor 30 can be U-shaped with the combustor inlet 100 forward of the combustor outlet 102, which can include the second portion 152 of the transition section 106 being longer than the primary section 104 (e.g., longer than the primary length 114), extending farther aft than the primary section 104, or both. The first portion 150 extends from the primary section 104 to the second portion 152. The cross-sectional area of the combustor inlet 100 can be within 5% of the cross-sectional area of the combustor outlet 102, which can provide a more consistent cross-sectional area between the combustor inlet 100 and the combustor outlet 102. The combustor centerline 132 can be curved in the first portion 150 of the transition section 106, can be straight in the primary section 104, can be straight in the second portion 152, or a combination thereof. The combustor inlet 100 can be forward of the combustor outlet by the axial offset 162 with at least some of the combustor 30 (e.g., the primary section 104 and the first portion 150) forward of the inlet 100. The illustrated configuration can allow for smaller engine diameters, which allows for lighter engines, can provide increased axial space for fuel injection and fuel manifolds without interfering with clearance control systems for the HP compressor 24 (FIG. 1), can provide more uniform turbine inlet conditions, or combinations thereof.

Referring to FIG. 3D, the combustor 30 can include an L-shaped configuration, which can include the primary section 104 being longer than the transition section 106. With the L-shaped configuration, the first angle 140 (FIG. 2) of the combustor centerline 132 at the combustor inlet 100 can be at least −30 degrees and less than 30 degrees. For example, the first angle 140 (FIG. 2) is shown as 0 degrees in FIG. 3D (e.g., parallel with the combustion section centerline 33 shown in FIG. 2). Additionally or alternatively, the second angle 142 can be at least 80 degrees and less than or equal to 90 degrees. With some examples, the combustor inlet 100 is perpendicular to the combustor outlet 102. The inlet height 110 can be less than the outlet height 112. With examples in which the second angle 142 is 90 degrees, the primary length 114 can be measured perpendicular to the combustion section centerline 33 (FIG. 2). The illustrated configuration can allow for shorter engine lengths and provide efficiencies (e.g., packaging benefits for interfacing) with a centrifugal compressor exit stage as the combustor 30 and the exit stage of the HP compressor 24 (FIG. 1) can extend radially and be adjacent to each other.

Referring to FIG. 3E, the combustor 30 can be devoid of the primary section 104 (FIG. 2) and the transition section 106 can extend from the combustor inlet 100 to the combustor outlet 102. With such configurations, the combustor centerline 132 can be curved at the combustor inlet 100 and be curved from the combustor inlet 100 through the turn 130 (e.g., through the first portion 150). Such configurations without the primary section 104 (FIG. 2) may not be practical with other designs, such as design utilizing liquid fuels, such as Jet-A, or fuels other than hydrogen. The primary length 114 (FIG. 2) is zero, so the second product is zero and the ratio of the first product to the second product is infinite. In some examples, the transition section 106 includes the second portion 152 that extends from the first portion 150 to the combustor outlet 102. In other examples, the first portion 150 extends from the combustor inlet 100 to the combustor outlet 102.

Referring to FIG. 4, a method 400 of forming a combustor is illustrated that can, for example, be utilized for the combustor 30 of FIGS. 1-3D. The method 400 includes forming the outer liner 41 (block 402), forming the inner liner 42 (block 404), and coupling the outer liner 41 with the inner liner (block 406), such as to form the combustion chamber 50 including the combustor inlet 100, the combustor outlet 102, the primary section 104, the transition section 106 defining the turn 130, or combinations thereof. Forming and coupling the outer liner 41 and the inner liner 42 in blocks 402-406 can include forming the outer liner 41 and the inner liner 42 such that the ratio of the first product (e.g., the combustor length 116 multiplied by the outlet height 112) to the second product (e.g., the primary length 114 multiplied by the inlet height 110) is at least 2, at least 2.5, or other values greater than 2, up to and including infinity (e.g., if the combustor 30 is formed without the primary section 104). Forming the outer liner 41 and the inner liner 42 in blocks 402 and 404 can include forming the outer liner 41 and the inner liner 42 with a U-shaped configuration or an L-shaped configuration. The outer liner 41 and the inner liner 42 can be formed and coupled such that the combustor inlet 100 and the combustor outlet 102 are radially offset and axially offset, such as with the combustor inlet 100 aft of the combustor outlet 102.

The illustrated configurations are not mutually exclusive. For example, the combustor 30 can include combinations of the configurations illustrated in FIGS. 2 and 3A-3E.

While described with respect to a turbine engine, it should be appreciated that the combustor as described herein can be for any engine having a combustor. It should be appreciated that application of aspects of the disclosure discussed herein are applicable to engines with propeller sections or fan and booster sections along with turbojets and turbo engines as well.

To the extent not already described, the different features and structures of the various embodiments can be used in combination, or in substitution with each other as desired. That one feature is not illustrated in all of the embodiments is not meant to be construed that it cannot be so illustrated but is done for brevity of description. Thus, the various features of the different embodiments can be mixed and matched as desired to form new embodiments, whether or not the new embodiments are expressly described. All combinations or permutations of features described herein are covered by this disclosure.

This written description uses examples to describe aspects of the disclosure described herein, including the best mode, and also to enable any person skilled in the art to practice aspects of the disclosure, including making and using any devices or systems and performing any incorporated methods. The patentable scope of aspects of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Further aspects are provided by the subject matter of the following clauses:

A gas turbine engine, comprising: a compressor section, a combustion section, and a turbine section, with the combustion section including: a flow turning combustor comprising: a combustor liner that at least partially defines a combustion chamber including: a combustor inlet having an inlet height, a combustor outlet having an outlet height and fluidly coupled with the turbine section, a primary section extending from the combustor inlet and including a primary length, and a transition section extending from the primary section to the combustor outlet and defining a turn; a hydrogen fuel supply; and a fuel nozzle assembly fluidly coupled with the hydrogen fuel supply and the combustor inlet; wherein the flow turning combustor defines a combustor centerline extending from the combustor inlet to the combustor outlet, and includes a combustor length measured along the combustor centerline from the combustor inlet to the combustor outlet; and wherein a ratio of a first product of the combustor length and the outlet height to a second product of the inlet height and the primary length is at least 2.

The gas turbine engine of any preceding clause, wherein the outlet height is greater than the inlet height.

The gas turbine engine of any preceding clause, wherein the inlet height is at least 20% and less than 150% of the outlet height.

The gas turbine engine of any preceding clause, wherein the combustor inlet is aft of the combustor outlet.

The gas turbine engine of any preceding clause, wherein the turn is at least 60 degrees and less than 240 degrees.

The gas turbine engine of any preceding clause, wherein the combustor centerline at the combustor outlet is angled at a first angle relative to a centerline of the combustion section.

The gas turbine engine of any preceding clause, wherein the first angle is at least −30 degrees and less than 30 degrees.

The gas turbine engine of any preceding clause, wherein the centerline at the combustor inlet is angled at a second angle relative to the centerline of the combustion section.

The gas turbine engine of any preceding clause, wherein the second angle is at least −30 degrees and less than 90 degrees.

The gas turbine engine of any preceding clause, wherein the second angle is at least 80 degrees.

The gas turbine engine of any preceding clause, wherein the combustor centerline includes a U-shaped configuration.

The gas turbine engine of any preceding clause, wherein the ratio is at least 2.5.

The gas turbine engine of any preceding clause, wherein the transition section includes a first portion defining the turn and a second portion that is straight.

The gas turbine engine of any preceding clause, wherein a radial offset between the combustor inlet and the combustor outlet is at least 30% and less than or equal to 250% of the outlet height.

The gas turbine engine of any preceding clause, wherein an axial offset between the combustor inlet and the combustor outlet is greater than 0% and less than or equal to 400% of the outlet height.

The gas turbine engine of any preceding clause, wherein the fuel nozzle assembly is positioned to emit hydrogen fuel forward into the combustor inlet.

The gas turbine engine of any preceding clause, wherein a cross-sectional area of the combustor inlet is less than a cross-sectional area of the combustor outlet.

The gas turbine engine of any preceding clause, wherein a radial offset between the combustor inlet and the combustor outlet is at least 30% and less than or equal to 250% of the outlet height.

The gas turbine engine of any preceding clause, wherein the radial offset is at least 120% and less than or equal to 200% of the outlet height.

The gas turbine engine of any preceding clause, wherein a cross-sectional area of the combustor inlet is within 5% of a cross-sectional area of the combustor outlet.

The gas turbine engine of any preceding clause, wherein the combustor inlet is forward of the combustor outlet.

The gas turbine engine of any preceding clause, wherein the transition section includes a first portion that defines the turn and a second portion extending from the first portion to the combustor outlet; and the second portion is longer than the primary section.

The gas turbine engine of any preceding clause, wherein the combustor centerline is curved in the first portion; and the combustor centerline is straight in the primary section and in the second portion.

The gas turbine engine of any preceding clause, wherein the combustor inlet is aft of combustor outlet.

The gas turbine engine of any preceding clause, wherein the combustor outlet is aft of the combustor inlet.

The gas turbine engine of any preceding clause, wherein a cross-sectional area of the combustor inlet is greater than a cross-sectional area of the combustor outlet.

The gas turbine engine of any preceding clause, wherein a cross-sectional area of the combustor inlet is less than a cross-sectional area of the combustor inlet.

The gas turbine engine of any preceding clause, wherein a combustor inlet height is greater than a combustor outlet height.

The gas turbine engine of any preceding clause, wherein a radial offset between the combustor inlet and the combustor outlet is at least 50% and less than or equal to 75% of the outlet height.

The gas turbine engine of any preceding clause, wherein the transition section includes a first portion that defines the turn and a second portion extending from the first portion to the combustor outlet; and the second portion is shorter than the primary section.

The gas turbine engine of any preceding clause, wherein the centerline at the combustor outlet is angled at a first angle relative to a centerline of the combustion section.

The gas turbine engine of any preceding clause, wherein the first angle is at least −30 degrees and less than 30 degrees.

The gas turbine engine of any preceding clause, wherein the centerline at the combustor inlet is angled at a second angle relative to the centerline of the combustion section.

The gas turbine engine of any preceding clause, wherein the second angle is at least −30 degrees and less than or equal to 90 degrees.

The gas turbine engine of any preceding clause, wherein the second angle is at least 80 degrees and less than or equal to 90 degrees.

The gas turbine engine of any preceding clause, wherein the combustor inlet is perpendicular to the combustor outlet.

The gas turbine engine of any preceding clause, wherein the primary section is longer than the transition section.

A flow turning hydrogen combustor for a gas turbine engine, the flow turning hydrogen combustor comprising: a combustor liner that at least partially defines a combustion chamber including: a combustor inlet having an inlet height and configured to receive hydrogen fuel from a hydrogen fuel supply; a combustor outlet having an outlet height and fluidly coupled with the turbine section; a primary section extending from the combustor inlet and including a primary length; and a transition section extending from the primary section to the combustor outlet and defining a turn; wherein the flow turning combustor defines a combustor centerline extending from the combustor inlet to the combustor outlet, and includes a combustor length measured along the centerline from the combustor inlet to the combustor outlet; and wherein a ratio of a first product of the combustor length and the outlet height to a second product of the inlet height and the primary length is at least 2.

The flow turning hydrogen combustor of any preceding clause, wherein the outlet height is greater than the inlet height.

The flow turning hydrogen combustor of any preceding clause, wherein the inlet height is at least 20% and less than 150% of the outlet height.

The flow turning hydrogen combustor of any preceding clause, wherein the combustor inlet is aft of the combustor outlet.

The flow turning hydrogen combustor of any preceding clause, wherein the turn is at least 60 degrees and less than 240 degrees.

The flow turning hydrogen combustor of any preceding clause, wherein the combustor centerline at the combustor outlet is angled at a first angle relative to a centerline of the combustion section.

The flow turning hydrogen combustor of any preceding clause, wherein the first angle is at least −30 degrees and less than 30 degrees.

The flow turning hydrogen combustor of any preceding clause, wherein the centerline at the combustor inlet is angled at a second angle relative to the centerline of the combustion section.

The flow turning hydrogen combustor of any preceding clause, wherein the second angle is at least −30 degrees and less than 90 degrees.

The flow turning hydrogen combustor of any preceding clause, wherein the second angle is at least 80 degrees.

The flow turning hydrogen combustor of any preceding clause, wherein the combustor centerline includes a U-shaped configuration.

The flow turning hydrogen combustor of any preceding clause, wherein the ratio is at least 2.5.

The flow turning hydrogen combustor of any preceding clause, wherein the transition section includes a first portion defining the turn and a second portion that is straight.

The flow turning hydrogen combustor of any preceding clause, wherein a radial offset between the combustor inlet and the combustor outlet is at least 30% and less than or equal to 250% of the outlet height.

The flow turning hydrogen combustor of any preceding clause, wherein an axial offset between the combustor inlet and the combustor outlet is greater than 0% and less than or equal to 400% of the outlet height.

The flow turning hydrogen combustor of any preceding clause, wherein the fuel nozzle assembly is positioned to emit hydrogen fuel forward into the combustor inlet.

The flow turning hydrogen combustor of any preceding clause, wherein a cross-sectional area of the combustor inlet is less than a cross-sectional area of the combustor outlet.

The flow turning hydrogen combustor of any preceding clause, wherein a radial offset between the combustor inlet and the combustor outlet is at least 30% and less than or equal to 250% of the outlet height.

The flow turning hydrogen combustor of any preceding clause, wherein the radial offset is at least 120% and less than or equal to 200% of the outlet height.

The flow turning hydrogen combustor of any preceding clause, wherein a cross-sectional area of the combustor inlet is within 5% of a cross-sectional area of the combustor outlet.

The flow turning hydrogen combustor of any preceding clause, wherein the combustor inlet is forward of the combustor outlet.

The flow turning hydrogen combustor of any preceding clause, wherein the transition section includes a first portion that defines the turn and a second portion extending from the first portion to the combustor outlet; and the second portion is longer than the primary section.

The flow turning hydrogen combustor of any preceding clause, wherein the combustor centerline is curved in the first portion; and the combustor centerline is straight in the primary section and in the second portion.

The flow turning hydrogen combustor of any preceding clause, wherein the combustor inlet is aft of combustor outlet.

The flow turning hydrogen combustor of any preceding clause, wherein the combustor outlet is aft of the combustor inlet.

The flow turning hydrogen combustor of any preceding clause, wherein a cross-sectional area of the combustor inlet is greater than a cross-sectional area of the combustor outlet.

The flow turning hydrogen combustor of any preceding clause, wherein a cross-sectional area of the combustor inlet is less than a cross-sectional area of the combustor inlet.

The flow turning hydrogen combustor of any preceding clause, wherein a combustor inlet height is greater than a combustor outlet height.

The flow turning hydrogen combustor of any preceding clause, wherein a radial offset between the combustor inlet and the combustor outlet is at least 50% and less than or equal to 75% of the outlet height.

The flow turning hydrogen combustor of any preceding clause, wherein the transition section includes a first portion that defines the turn and a second portion extending from the first portion to the combustor outlet; and the second portion is shorter than the primary section.

The flow turning hydrogen combustor of any preceding clause, wherein the transition section defines a plurality of turns including the turn.

The flow turning hydrogen combustor of any preceding clause, wherein the centerline at the combustor outlet is angled at a first angle relative to a centerline of the combustion section.

The flow turning hydrogen combustor of any preceding clause, wherein the first angle is at least −30 degrees and less than 30 degrees.

The flow turning hydrogen combustor of any preceding clause, wherein the centerline at the combustor inlet is angled at a second angle relative to the centerline of the combustion section.

The flow turning hydrogen combustor of any preceding clause, wherein the second angle is at least −30 degrees and less than or equal to 90 degrees.

The flow turning hydrogen combustor of any preceding clause, wherein the second angle is at least 80 degrees and less than or equal to 90 degrees.

The flow turning hydrogen combustor of any preceding clause, wherein the combustor inlet is perpendicular to the combustor outlet.

The flow turning hydrogen combustor of any preceding clause, wherein the primary section is longer than the transition section.

A gas turbine engine, comprising: compressor section, a combustion section, and a turbine section, with the combustion section including: a flow turning combustor comprising: a combustor liner that at least partially defines a combustion chamber including: a combustor inlet having an inlet height, a combustor outlet having an outlet height and fluidly coupled with the turbine section, and a transition section extending from the combustor inlet to the combustor outlet and defining a turn; a hydrogen fuel supply; and a fuel nozzle assembly fluidly coupled with the hydrogen fuel supply and the combustor inlet; wherein the flow turning combustor defines a combustor centerline extending from the combustor inlet to the combustor outlet; and wherein the combustor centerline is curved from the combustor inlet through the turn.

The gas turbine engine of any preceding clause, wherein an axial offset between the combustor inlet and the combustor outlet is greater than 0% and less than or equal to 400% of the outlet height.

The gas turbine engine of any preceding clause, wherein a radial offset between the combustor inlet and the combustor outlet is at least 30% and less than or equal to 250% of the outlet height.

The gas turbine engine of any preceding clause, wherein the fuel nozzle assembly is positioned to emit hydrogen fuel forward into the combustor inlet.

The gas turbine engine of any preceding clause, wherein the combustor inlet is aft of the combustor outlet.

A flow turning hydrogen combustor comprising: a combustor liner that at least partially defines a combustion chamber including: a combustor inlet having an inlet height, a combustor outlet having an outlet height, and a transition section extending from the combustor inlet to the combustor outlet and defining a turn; wherein the flow turning combustor defines a combustor centerline extending from the combustor inlet to the combustor outlet; and wherein the combustor centerline is curved from the combustor inlet through the turn.

The flow turning combustor of any preceding clause, wherein an axial offset between the combustor inlet and the combustor outlet is greater than 0% and less than or equal to 400% of the outlet height.

The flow turning combustor of any preceding clause, wherein a radial offset between the combustor inlet and the combustor outlet is at least 30% and less than or equal to 250% of the outlet height.

The flow turning combustor of any preceding clause, wherein the fuel nozzle assembly is positioned to emit hydrogen fuel forward into the combustor inlet.

The flow turning combustor of any preceding clause, wherein the combustor inlet is aft of the combustor outlet.

A method of forming a flow turning hydrogen combustor, the method comprising: forming an outer liner; forming an inner liner; and coupling the outer liner with the inner liner to form a combustion chamber including a combustor inlet, a combustor outlet, a primary section, and a transition section defining a turn, the combustion chamber defining a combustor length from the combustor inlet to the combustor outlet; wherein the combustor inlet includes an inlet height, the combustor outlet includes an outlet height, and the primary section includes a primary length; and wherein the outer liner and the inner liner are formed and coupled such that a ratio of a first product of the combustor length and the outlet height to a second product of the primary length and the inlet height is at least 2 and less than 30.

The method of any preceding clause, wherein forming the outer liner and the inner liner includes forming the outer liner and the inner liner with a U-shaped configuration or an L-shaped configuration.

The method of any preceding clause, wherein forming the outer liner and the inner liner includes forming the outer liner and the inner liner such that a combustor centerline at the combustor outlet is angled at a first angle and the combustor centerline at the combustor inlet is angled at a second angle.

The method of any preceding clause, wherein the first angle is at least −30 degrees and less than or equal to 30 degrees.

The method of any preceding clause, wherein the second angle is at least −30 degrees and less than or equal to 90 degrees.

The method of any preceding clause, wherein the second angle is at least 80 degrees.

The method of any preceding clause, wherein the ratio is at least 2.5.

The method of any preceding clause, wherein the outer liner and the inner liner are formed and coupled such that the combustor inlet and the combustor outlet are radially offset and axially offset.

1. A gas turbine engine, comprising:
a compressor section, a combustion section, and a turbine section, with the combustion section including:
a flow turning combustor comprising:
a combustor liner that at least partially defines a combustion chamber including:
a combustor inlet having an inlet height,
a combustor outlet having an outlet height and fluidly coupled with the turbine section,
a primary section extending from the combustor inlet and including a primary length, and
a transition section extending from the primary section to the combustor outlet and defining a turn;
a hydrogen fuel supply; and
a fuel nozzle assembly fluidly coupled with the hydrogen fuel supply and the combustor inlet;
wherein the flow turning combustor defines a combustor centerline extending from the combustor inlet to the combustor outlet, and includes a combustor length measured along the combustor centerline from the combustor inlet to the combustor outlet; and
wherein a ratio of a first product of the combustor length and the outlet height to a second product of the inlet height and the primary length is at least 2.

2. The gas turbine engine of claim 1, wherein the outlet height is greater than the inlet height.

3. The gas turbine engine of claim 1, wherein the combustor inlet is aft of the combustor outlet.

4. The gas turbine engine of claim 1, wherein the turn is at least 60 degrees and less than 240 degrees.

5. The gas turbine engine of claim 1, wherein the combustor centerline at the combustor outlet is angled at a first angle relative to a centerline of the combustion section; and
wherein the first angle is at least −30 degrees and less than 30 degrees.

6. The gas turbine engine of claim 5, wherein the centerline at the combustor inlet is angled at a second angle relative to the centerline of the combustion section; and
wherein the second angle is at least −30 degrees and less than or equal to 90 degrees.

7. The flow turning hydrogen combustor of claim 6, wherein the second angle is at least 80 degrees and less than or equal to 90 degrees.

8. The flow turning hydrogen combustor of claim 1, wherein the combustor inlet is perpendicular to the combustor outlet.

9. The flow turning hydrogen combustor of claim 1, wherein the primary section is longer than the transition section.

10. The gas turbine engine of claim 1, wherein the combustor centerline includes a U-shaped configuration.

11. The gas turbine engine of claim 1, wherein the transition section includes a first portion defining the turn and a second portion that is straight.

12. The gas turbine engine of claim 1, wherein an axial offset between the combustor inlet and the combustor outlet is greater than 0% and less than or equal to 400% of the outlet height, wherein the axial offset is measured in an axial direction along the combustor centerline between an aftmost portion of the combustor inlet and an aftmost portion of the combustor outlet.

13. The gas turbine engine of claim 1, wherein the fuel nozzle assembly is positioned to emit hydrogen fuel forward into the combustor inlet.

14. The gas turbine engine of claim 12, wherein a radial offset between the combustor inlet and the combustor outlet is at least 30% and less than or equal to 250% of the outlet height,
wherein the radial offset is measured in a radial direction between a most radially inward portion of the combustor inlet and a most radially outward portion of the combustor outlet.

15. The flow turning hydrogen combustor of claim 14, wherein the radial offset is at least 50% and less than or equal to 75% of the outlet height.

16. The gas turbine engine of claim 1, wherein the transition section includes a first portion that defines the turn and a second portion extending from the first portion to the combustor outlet; and
wherein the second portion is longer than the primary section.

17. The gas turbine engine of claim 16, wherein the combustor centerline is curved in the first portion; and
the combustor centerline is straight in the primary section and in the second portion.

18. The gas turbine engine of claim 1, wherein a cross-sectional area of the combustor inlet is less than a cross-sectional area of the combustor outlet.

19. The gas turbine engine of claim 1, wherein a cross-sectional area of the combustor inlet is within 5% of a cross-sectional area of the combustor outlet.

20. The flow turning hydrogen combustor of claim 1, wherein a combustor inlet height is greater than a combustor outlet height.
